(19) United States
(12) Patent Application Publication
(10) Pub. No.: US 2013/0166376 A1
(43) Pub. Date: Jun. 27, 2013

(54) TRACKING CONVERSIONS OF APPLICATION SOFTWARE ADVERTISEMENTS

(71) Applicants: NIR COHEN, Rishon Lezion (IL); Tal Hashai, Tel-Aviv (IL)

(72) Inventors: NIR COHEN, Rishon Lezion (IL); Tal Hashai, Tel-Aviv (IL)

(21) Appl. No.: 13/337,336

(22) Filed: Dec. 27, 2011

(51) Int. Cl. G06Q 30/02

(52) U.S. Cl. 705/14.45

(57) ABSTRACT

Tracking a conversion of a computer-based advertisement by receiving from a first software application running on a computing device a notification that a user interaction event has occurred in association with an advertisement, associating an identifier with the user responsive to receiving the notification, providing the identifier to the first software application, receiving the identifier from the first software application, and recording a conversion event in association with the advertisement responsive to receiving the identifier from the first software application.

### FIELD OF THE INVENTION

The present invention relates to computer-based advertising in general, and more particularly to tracking conversions of application software advertisements.

### BACKGROUND OF THE INVENTION

Computer software applications are often advertised within computer-based documents, such as Internet-based web pages, or even within other software applications, such as mobile telephone-based application software, or “apps.” Typically, such advertisements are managed by online advertising networks, or “ad networks,” that provide advertisements for presentation to potential customers. The advertisements typically include hypertext links that direct customers to web sites where advertised software may be acquired, such as to so-called “app stores.”

An advertiser of a computer software application may wish to gauge the effectiveness of an advertising campaign by determining its “conversion rate,” which the advertiser may define as the rate at which presentations of advertisements to computer users result in the advertised application being acquired (e.g., downloaded) by the computer users. One known method for capturing such conversions may be illustrated by way of the example shown in FIGS. 1A and 1B, where in FIG. 1A a computing device 100 is shown running an app 102 which receives an advertisement 104 from an ad network 106, where advertisement 104 is displayed by app 102 and advertises another app 108 that is available at an app store 110. App 102 is configured such that when a user of computing device 100 interacts with advertisement 104, such as by “clicking” on advertisement 104 using a pointing device, app 102 informs ad network 106 that advertisement 104 was clicked and provides ad network 106 with an identifier stored on computing device 100 and that uniquely identifies computing device 100, which ad network 106 retains in a store 112. Computing device 100 is then directed to a location indicated by advertisement 104, such as to app store 110 where the user acquires the advertised app 108. As shown in FIG. 1B, app 108 is configured such that the first time the user runs app 108 on computing device 100, app 108 informs ad network 106 that app 108 was run, and likewise provides ad network 106 with the same unique identifier stored on computing device 100 (and store 112) that app 108 previously provided to ad network 106 when the user clicked on advertisement 104. In this manner ad network 106 is able to correlate the user's interaction with advertisement 104 with the user's acquisition of app 108 and records in a store 114 (FIG. 1B) that a conversion event has occurred.

While the method shown in FIGS. 1A and 1B is operative with respect to a single ad network, a solution that would enable an advertiser of a computer software application to advertise the application via multiple ad networks and capture conversion events centrally would be advantageous. Moreover, an advertiser may not have full access and control to information obtained and stored by ad networks, hence, an independent solution would also be advantageous.

### SUMMARY OF THE INVENTION

In one aspect of the invention a method is provided for tracking a conversion of a computer-based advertisement, the method including receiving from a first software application running on a computing device a notification that a user interaction event has occurred in association with an advertisement, associating an identifier with the user responsive to receiving the notification, providing the identifier to the first software application, receiving the identifier from the first software application, and recording a conversion event in association with the advertisement responsive to receiving the identifier from the first software application.

In another aspect of the invention the receiving the notification is performed where the advertisement is presented by a second software application running on the computing device.

In another aspect of the invention the receiving the notification is performed where the second software application causes the first software application to transmit the notification.

In another aspect of the invention the providing includes redirecting the first software application to a network address where application software that is associated with the advertisement is acquirable.

In another aspect of the invention the receiving the identifier is performed subsequent to application software that is associated with the advertisement being acquired by the computing device.

In another aspect of the invention the receiving the identifier is performed subsequent to application software that is associated with the advertisement causing the first software application to transmit the identifier.

In another aspect of the invention the receiving the identifier is performed the first time application software associated with the advertisement runs on the computing device.

In another aspect of the invention the method further includes instructing the first software application to cause application software associated with the advertisement running on the computing device to have focus.

In another aspect of the invention the method further includes calculating an estimated conversion rate in accordance with a predefined function applied to a number of reported installations on a plurality of computing devices of application software associated with the advertisement, a number of ratings received for the application software associated with the advertisement, and a number of ratings received for the application software associated with the advertisement together with the identifier.

In another aspect of the invention a system is provided for tracking a conversion of a computer-based advertisement, the system including an identifier manager configured to receive from a first software application running on a computing device a notification that a user interaction event has occurred in association with an advertisement, associate an identifier with the user responsive to receiving the notification, and provide the identifier to the first software application, and a correlation detector configured to receive the identifier from the first software application, and record a conversion event in association with the advertisement responsive to receiving the identifier from the first software application.

In another aspect of the invention the advertisement is presented by a second software application running on the computing device.

In another aspect of the invention the second software application is configured to cause the first software application to transmit the notification.

In another aspect of the invention the identifier manager is configured to redirect the first software application to a network address where application software that is associated with the advertisement is acquirable.

In another aspect of the invention application software that is associated with the advertisement is acquired by the computing device prior to the first software application transmitting the identifier.

In another aspect of the invention application software that is associated with the advertisement causes the first software application to transmit the identifier.

In another aspect of the invention the first software application transmits the identifier the first time application software that is associated with the advertisement runs on the computing device.

In another aspect of the invention the correlation detector is configured to instruct the first software application to cause application software that is associated with the advertisement and that is running on the computing device to have focus.

In another aspect of the invention the system further includes a conversion rate estimator configured to calculate an estimated conversion rate in accordance with a predefined function applied to a number of reported installations of a third software application on a plurality of computing devices, a number of ratings received for the third software application, and a number of ratings received for the third software application together with the identifier.

In another aspect of the invention a computer program product is provided for tracking a conversion of a computer-based advertisement, the computer program product including a computer-readable storage medium, and computer-readable program code embodied in the computer-readable storage medium, where the computer-readable program code is configured to receive from a first software application running on a computing device a notification that a user interaction event has occurred in association with an advertisement, associate an identifier with the user responsive to receiving the notification, provide the identifier to the first software application, receive the identifier from the first software application, and record a conversion event in association with the advertisement responsive to receiving the identifier from the first software application.

In another aspect of the invention the computer-readable program code is configured to receive the notification where the advertisement is presented by a second software application running on the computing device.

In another aspect of the invention the computer-readable program code is configured to receive the notification where the second software application causes the first software application to transmit the notification.

In another aspect of the invention the computer-readable program code is configured to redirect the first software application to a network address where application software that is associated with the advertisement is acquirable.

In another aspect of the invention the computer-readable program code is configured to receive the identifier subsequent to application software that is associated with the advertisement being acquired by the computing device.

In another aspect of the invention the computer-readable program code is configured to receive the identifier subsequent to application software that is associated with the advertisement causing the first software application to transmit the identifier.

In another aspect of the invention the computer-readable program code is configured to receive the identifier the first time application software associated with the advertisement runs on the computing device.

In another aspect of the invention where the computer-readable program code is configured to instruct the first software application to cause application software associated with the advertisement running on the computing device to have focus.

In another aspect of the invention where the computer-readable program code is configured to calculate an estimated conversion rate in accordance with a predefined function applied to a number of reported installations on a plurality of computing devices of application software associated with the advertisement, a number of ratings received for the application software associated with the advertisement, and a number of ratings received for the application software associated with the advertisement together with the identifier.

### BRIEF DESCRIPTION OF THE DRAWINGS

The invention will be understood and appreciated more fully from the following detailed description taken in conjunction with the appended drawings in which:

FIGS. 1A and 1B, taken together, is a simplified conceptual illustration of a prior art system for tracking conversions of application software advertisements;

FIGS. 2A and 2B, taken together, is a simplified conceptual illustration of a system for tracking conversions of application software advertisements, constructed and operative in accordance with an embodiment of the invention;

FIGS. 3A and 3B, taken together, is a simplified action diagram of an exemplary method of operation of the system of FIGS. 2A and 2B, operative in accordance with an embodiment of the invention;

FIGS. 4A and 4B, taken together, is a simplified conceptual illustration of an alternative system for tracking conversions of application software advertisements, constructed and operative in accordance with an embodiment of the invention; and

FIG. 5 is a simplified flowchart illustration of an exemplary method of operation of the system of FIGS. 4A and 4B, operative in accordance with an embodiment of the invention.

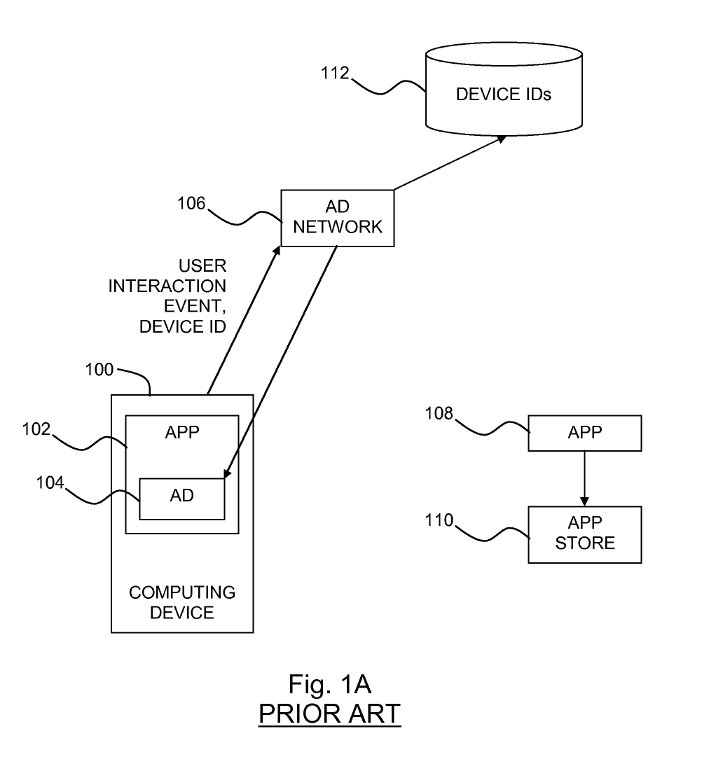

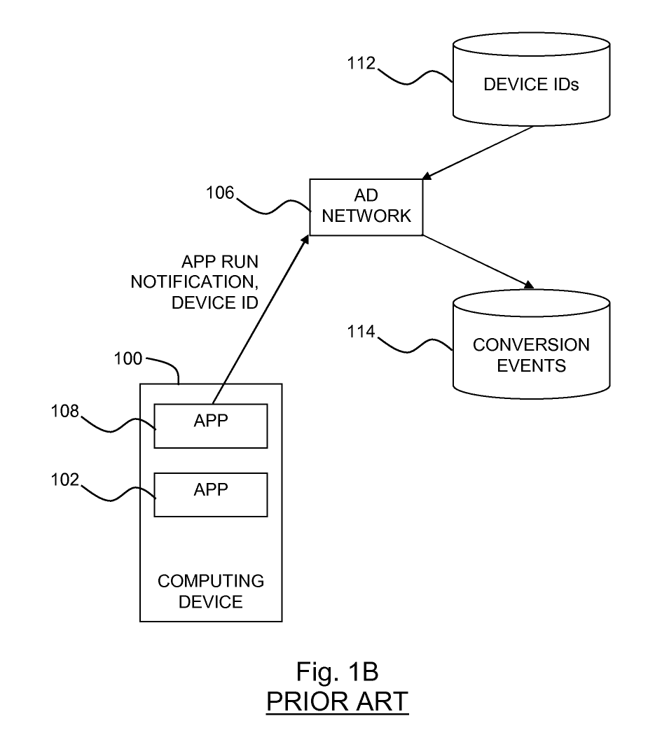

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

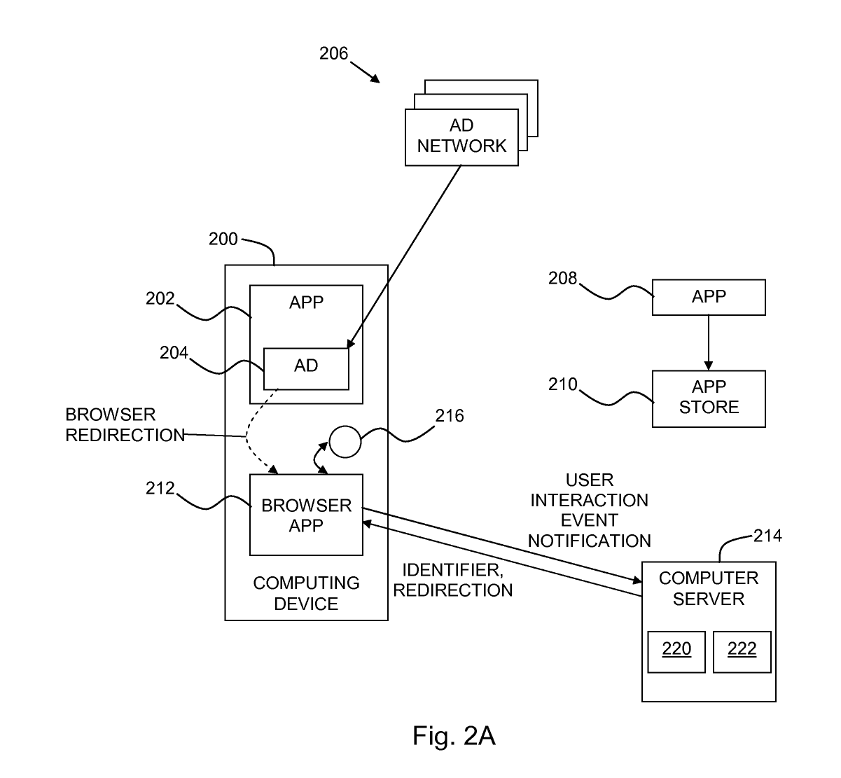

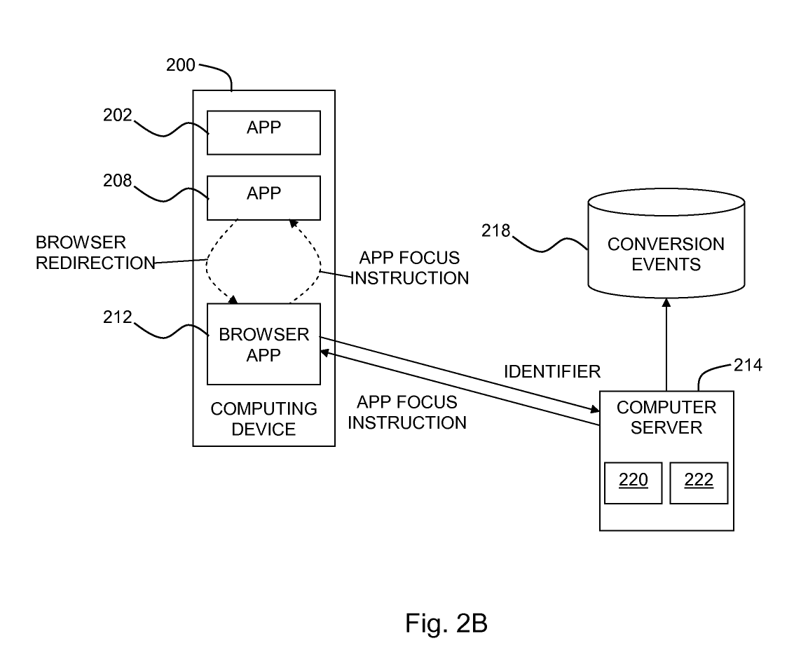

Reference is now made to FIGS. 2A and 2B which, taken together, is a simplified conceptual illustration of a system for tracking conversions of application software advertisements, constructed and operative in accordance with an embodiment of the invention. In FIG. 2A a computing device 200, such as a mobile telephone or a personal computer, is shown running application software 202, now referred to as app 202, which receives an advertisement 204 from any of a group of ad networks 206. Advertisement 204 is typically presented by app 202, such as by displaying advertisement 204 on a display of computing device 200, such as for the purpose of advertising application software 208, now referred to as app 208, that is available for acquisition, such as at an online app store 210. App 202 is configured such that when a user of computing device 200 interacts with advertisement 204, such as by “clicking” on advertisement 204 using a pointing device, app 202 causes a browser application 212 on computing device 200 to navigate to a network address, such as at a computer server 214, that is indicated by advertisement 204, thereby providing a notification to computer server 214 that a user interaction event has occurred in association with advertisement 204. Computer server 214 preferably includes an identifier manager 220 that is configured to associate a unique identifier with the user in response to receiving the notification of the user interaction event, and provide the identifier to browser application 212, such as in a cookie 216 which browser application 212 preferably maintains at computing device 200. Preferably, the unique identifier includes an identification of advertisement 204 with which the user interacted, information about the user, such as the user's location, information about the user interaction with advertisement 104, such as the length of time that advertisement 104 was presented by app 202 before the user interacted with advertisement 104, information about past user activities, such as previous user interactions with other advertisements and/or other information.

As shown in FIG. 2B, app 208 is configured such that when, and preferably the first time when, the user runs app 208 on computing device 200, such as after acquiring app 208 from app store 210, app 208 causes browser application 212 to navigate to a network address, such as a network address at computer server 214 that is uniquely associated with advertisement 204 and/or app 208, or at a third-party server, whereupon computer server 214 causes browser application 212 to provide to computer server 214 the identifier that browser application 212 previously received from computer server 214. Computer server 214 preferably includes a correlation detector 222 that is configured to correlate, by virtue of having received the identifier, the user's interaction with advertisement 204 with a conversion event in the form of the user's acquisition of app 208, and preferably record, such as in a data storage device 218, that a conversion event has occurred. Correlation detector 222 then preferably instructs browser application 212 to cause app 208 to have focus, such as by placing app 208 in a state where app 208 is able to accept user input.

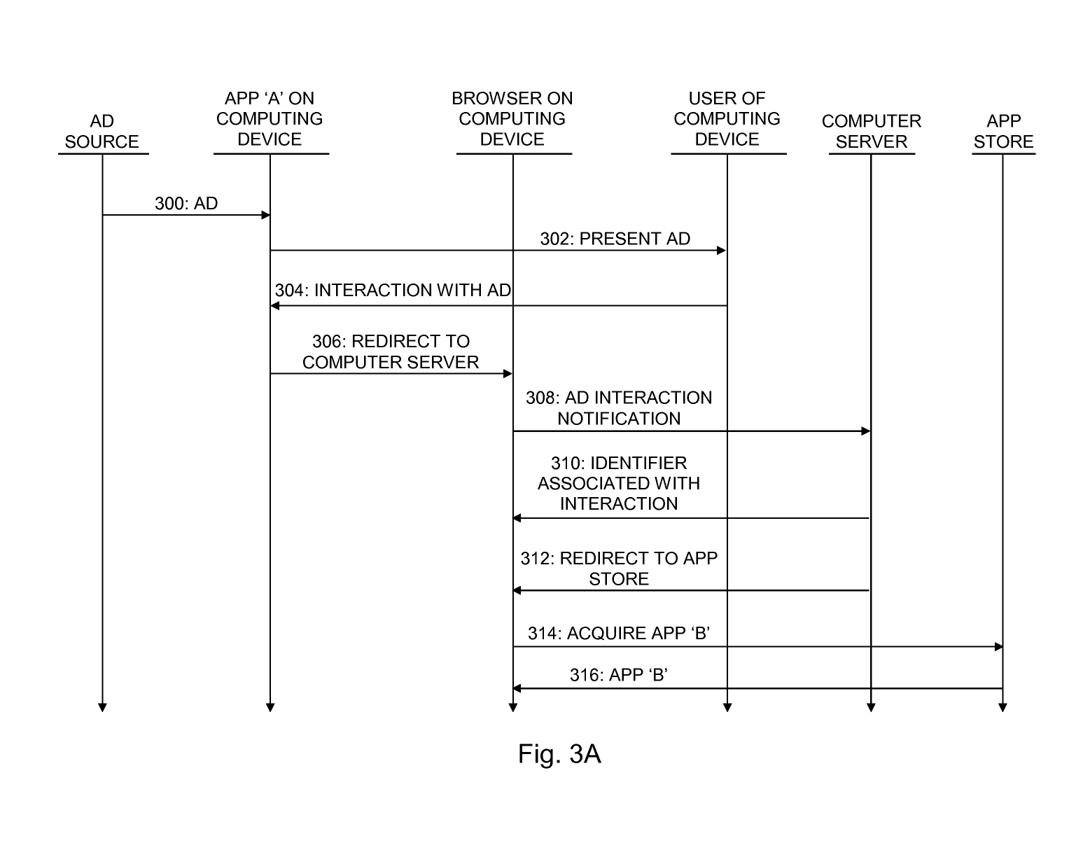

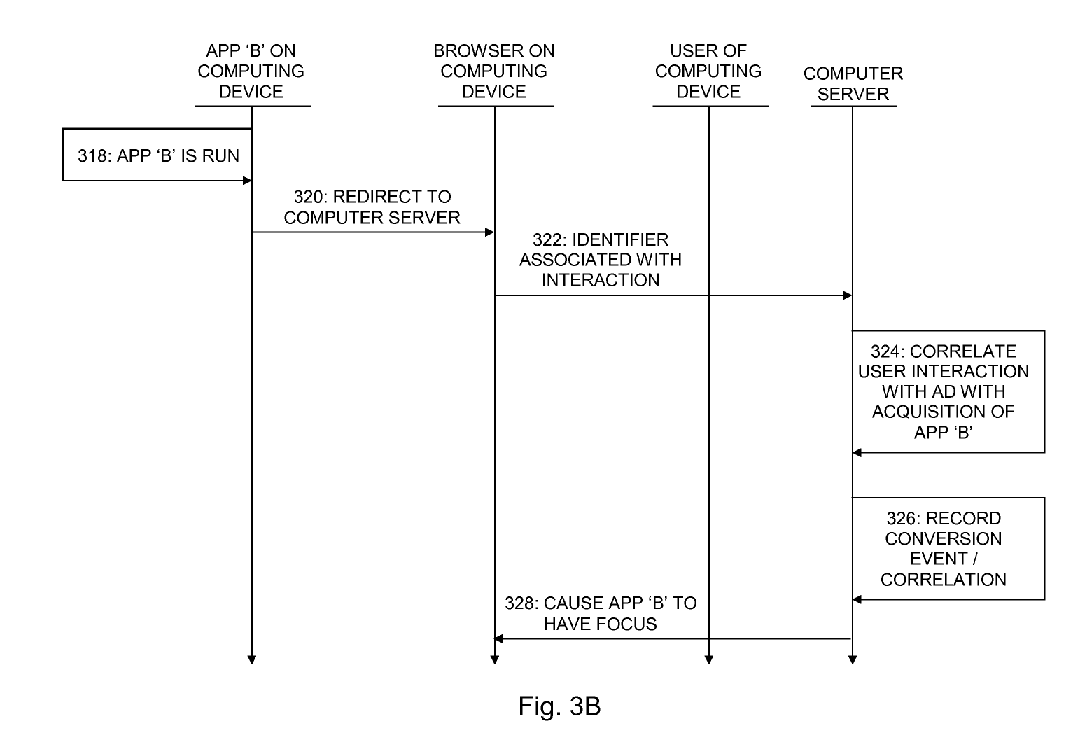

Reference is now made to FIGS. 3A and 3B, which, taken together, is a simplified action diagram of an exemplary method of operation of the system of FIGS. 2A and 2B, operative in accordance with an embodiment of the invention. In the method of FIGS. 3A and 3B, a software application (i.e., “app”) ‘A’ running on a computing device, such as a mobile telephone or a personal computer, receives an advertisement, such as for an app ‘B’ (step 300). App ‘A’ presents the advertisement, such as by displaying the advertisement on a display of the computing device (step 302). When a user of the computing device interacts with the advertisement, such as by “clicking” on the advertisement using a pointing device (step 304), app ‘A’ causes a browser application on the computing device to navigate to a network address, such as at a computer server, that is indicated by the advertisement (step 306), thereby providing a notification to the computer server that a user interaction event has occurred in association with the advertisement (step 308). The computer server associates a unique identifier with the user interaction, where the identifier preferably includes an identification of advertisement 204 and/or other information as described above, and provides the identifier to the browser application, such as in a cookie which the browser application maintains at the computing device (step 310). The computer server redirects the browser application to a network address where app ‘B’ may be such as to the network address of an app store (step 312), whereupon app ‘B’ is acquired by the computing device (steps 314 and 316).

When, and preferably the first time when, the user runs app ‘B’ on the computing device (step 318), app ‘B’ causes the browser application on the computing device to navigate to a network address, such as a network address at the computer server that is uniquely associated with the advertisement and/or with app ‘B’ (step 320), whereupon the computer server causes the browser application to provide to the computer server the unique identifier that the browser application previously received from the computer server (step 322). In this manner the computer server is able to correlate the user's interaction with the advertisement with the user's acquisition of app ‘B’ (step 324) and records that a conversion event has occurred and/or otherwise records that a correlation has been found, where the unique identifier and/or any other information relating to the interaction and/or the conversion event may also be recorded (step 326). The computer server then instructs the browser application to cause app ‘B’ to have focus, such as by placing app ‘B’ in a state where app ‘B’ is able to accept user input (step 328).

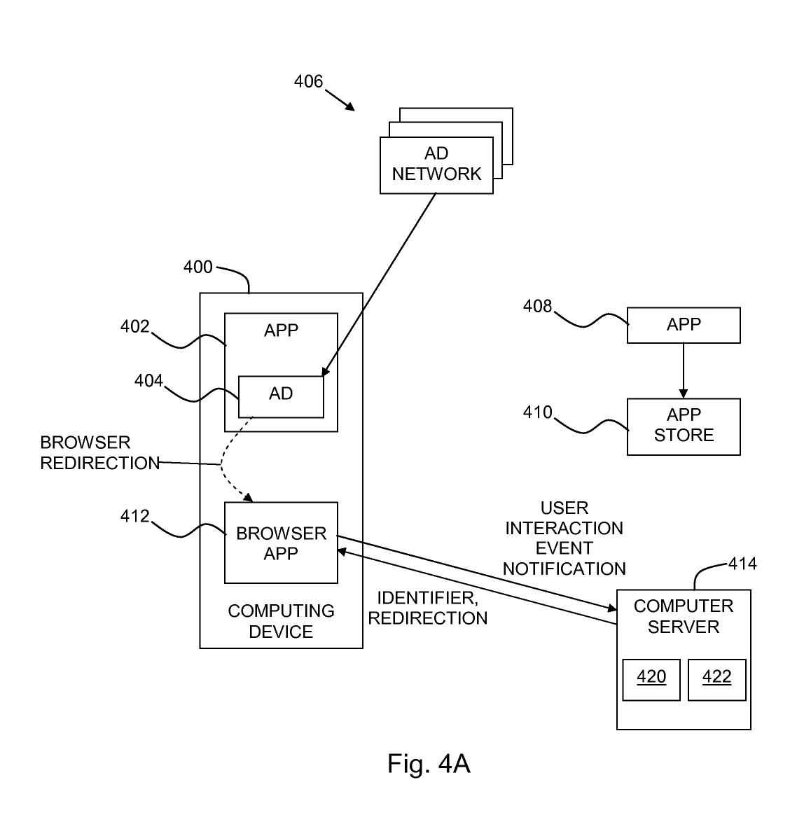

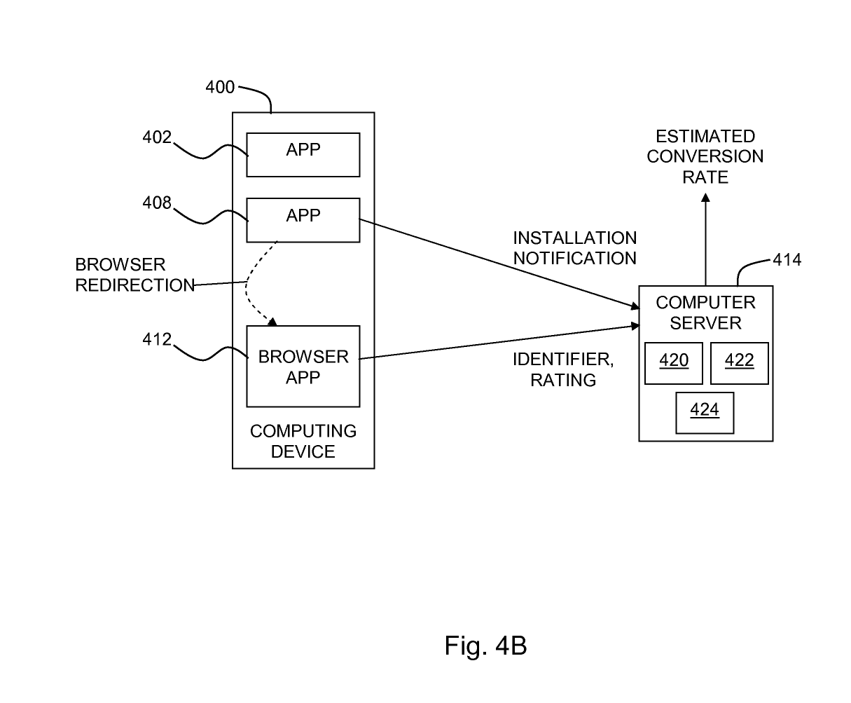

Reference is now made to FIGS. 4A and 4B which, taken together, is a simplified conceptual illustration of an alternative system for tracking conversions of application software advertisements, constructed and operative in accordance with an embodiment of the invention. Elements 400-414, 420, and 422 in FIG. 4A are preferably identical to that which is described hereinabove with reference to elements 200-214, 220, and 222 respectively in FIG. 2A. However, as shown in FIG. 4B, app 408 is configured such that when, and preferably the first time when, the user runs app 408 on computing device 400, whether or not app 408 was acquired after clicking on advertisement 404, app 408 merely informs computer server 414 that app 408 has been installed on computing device 400. App 408 may be configured such that when the user wishes to rate app 408 the user may select a predefined rating operation within app 408, which causes browser application 412 to navigate to a network address, such as a network address at computer server 414 that is uniquely associated with the rating operation, whereupon computer server 414 causes browser application 412 to provide to computer server 414 the identifier that browser application 412 previously received from computer server 414 if the user clicked on advertisement 404. However, if the user did not click on advertisement 404, and therefore did not receive the identifier, browser application 412 does not provide an identifier to computer server 414. Assuming that computer users that acquire app 408 after clicking on advertisement 404 provide a rating for app 408 at computer server 414 at the same rate as all computer users that acquire app 408, a conversion rate estimator 424 preferably calculates an estimated conversion rate may be calculated as follows:
X=Number of reported installations of app 408
Y=Total number of ratings received for app 408
Z=Number of ratings received for app 408 together with identifier
(Z*X)/Y=Number of conversions associated with interaction events for advertisement 404.

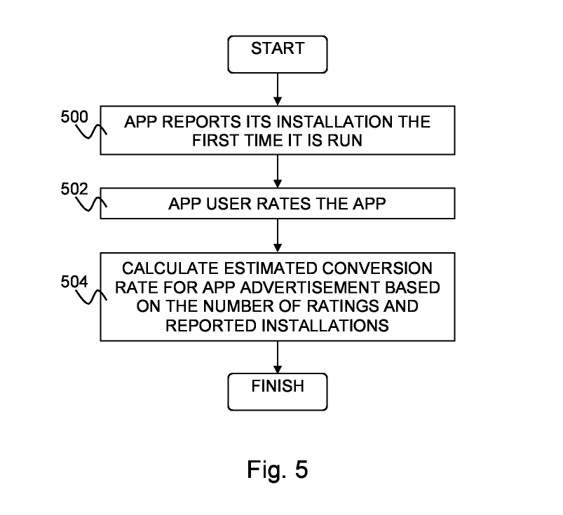

Reference is now made to FIG. 5, which is a simplified flowchart illustration of an exemplary method of operation of the system of FIGS. 4A and 4B, operative in accordance with an embodiment of the invention. In the method of FIG. 5, when, and preferably the first time when, the user runs an app on a computing device, the app informs a computer server that that the app has been installed on the computing device (step 500). When the user wishes to rate the app, the user may select a predefined rating operation within the app, which causes a browser application on the computing device to navigate to a network address, such as a network address at the computer server that is uniquely associated with the rating operation, whereupon the user may provide a rating (step 502). Assuming that computer users that acquire the app after clicking on advertisement for the app provide a rating for the app at computer server at the same rate as all computer users that acquire the app, an estimated conversion rate may be calculated based on the number of ratings and reported installations (step 504) such as using the calculation described hereinabove with reference to FIGS. 4A and 4B.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for tracking a conversion of a computer-based advertisement, the method comprising:
receiving from a first software application running on a computing device a notification that a user interaction event has occurred in association with an advertisement;
associating an identifier with the user responsive to receiving the notification;
providing the identifier to the first software application;
receiving the identifier from the first software application; and
recording a conversion event in association with the advertisement responsive to receiving the identifier from the first software application.

2. The method of claim 1 wherein the receiving the notification is performed where the advertisement is presented by a second software application running on the computing device.

3. The method of claim 2 wherein the receiving the notification is performed where the second software application causes the first software application to transmit the notification.

4. The method of claim 1 wherein the providing comprises redirecting the first software application to a network address where application software that is associated with the advertisement is acquirable.

5. The method of claim 1 wherein the receiving the identifier is performed subsequent to application software that is associated with the advertisement being acquired by the computing device.

6. The method of claim 1 wherein the receiving the identifier is performed subsequent to application software that is associated with the advertisement causing the first software application to transmit the identifier.

7. The method of claim 1 wherein the receiving the identifier is performed the first time application software associated with the advertisement runs on the computing device.

8. The method of claim 1 and further comprising instructing the first software application to cause application software associated with the advertisement running on the computing device to have focus.

9. The method of claim 1 and further comprising calculating an estimated conversion rate in accordance with a predefined function applied to a number of reported installations on a plurality of computing devices of application software associated with the advertisement, a number of ratings received for the application software associated with the advertisement, and a number of ratings received for the application software associated with the advertisement together with the identifier.

10. A system for tracking a conversion of a computer-based advertisement, the system comprising:
an identifier manager configured to
receive from a first software application running on a computing device a notification that a user interaction event has occurred in association with an advertisement,
associate an identifier with the user responsive to receiving the notification, and
provide the identifier to the first software application; and
a correlation detector configured to
receive the identifier from the first software application, and
record a conversion event in association with the advertisement responsive to receiving the identifier from the first software application.

11. The system of claim 10 wherein the advertisement is presented by a second software application running on the computing device.

12. The system of claim 11 wherein the second software application is configured to cause the first software application to transmit the notification.

13. The system of claim 10 wherein the identifier manager is configured to redirect the first software application to a network address where application software that is associated with the advertisement is acquirable.

14. The system of claim 10 wherein application software that is associated with the advertisement is acquired by the computing device prior to the first software application transmitting the identifier.

15. The system of claim 10 wherein application software that is associated with the advertisement causes the first software application to transmit the identifier.

16. The system of claim 10 wherein the first software application transmits the identifier the first time application software that is associated with the advertisement runs on the computing device.

17. The system of claim 10 wherein the correlation detector is configured to instruct the first software application to cause application software that is associated with the advertisement and that is running on the computing device to have focus.

18. The system of claim 10 and further comprising a conversion rate estimator configured to calculate an estimated conversion rate in accordance with a predefined function applied to a number of reported installations of a third software application on a plurality of computing devices, a number of ratings received for the third software application, and a number of ratings received for the third software application together with the identifier.

19. A computer program product for tracking a conversion of a computer-based advertisement, the computer program product comprising:
a computer-readable storage medium; and
computer-readable program code embodied in the computer-readable storage medium, wherein the computer-readable program code is configured to
receive from a first software application running on a computing device a notification that a user interaction event has occurred in association with an advertisement,
associate an identifier with the user responsive to receiving the notification,
provide the identifier to the first software application,
receive the identifier from the first software application, and
record a conversion event in association with the advertisement responsive to receiving the identifier from the first software application.

20. The computer program product of claim 19 wherein the computer-readable program code is configured to receive the notification where the advertisement is presented by a second software application running on the computing device.

21. The computer program product of claim 20 wherein the computer-readable program code is configured to receive the notification where the second software application causes the first software application to transmit the notification.

22. The computer program product of claim 19 wherein the computer-readable program code is configured to redirect the first software application to a network address where application software that is associated with the advertisement is acquirable.

23. The computer program product of claim 19 wherein the computer-readable program code is configured to receive the identifier subsequent to application software that is associated with the advertisement being acquired by the computing device.

24. The computer program product of claim 19 wherein the computer-readable program code is configured to receive the identifier subsequent to application software that is associated with the advertisement causing the first software application to transmit the identifier.

25. The computer program product of claim 19 wherein the computer-readable program code is configured to receive the identifier the first time application software associated with the advertisement runs on the computing device.

26. The computer program product of claim 19 wherein the computer-readable program code is configured to instruct the first software application to cause application software associated with the advertisement running on the computing device to have focus.

27. The computer program product of claim 19 wherein the computer-readable program code is configured to calculate an estimated conversion rate in accordance with a predefined function applied to a number of reported installations on a plurality of computing devices of application software associated with the advertisement, a number of ratings received for the application software associated with the advertisement, and a number of ratings received for the application software associated with the advertisement together with the identifier.
